(19) United States
(12) Patent Application Publication
(10) Pub. No.: US 2014/0015362 A1
(43) Pub. Date: Jan. 16, 2014

(54) SPHERE ZONE COUPLING OF MAGNETIC DEVICES AND MULTIPLE APPLICATIONS

(71) Applicant: Hsi-Chieh CHENG, Nan-Tou City (TW)

(72) Inventor: Hsi-Chieh CHENG, Nan-Tou City (TW)

(21) Appl. No.: 13/549,009

(22) Filed: Jul. 13, 2012

(51) Int. Cl. H02K 49/00

(52) U.S. Cl. 310/99

(57) ABSTRACT

A sphere zone coupling of magnetic devices has a first rotor containing permanent magnet array and a second rotor. The first rotor and the second rotor have the sphere zone surfaces forming from magnetic array or similar of almost the same sphere radius facing with constant air gap at overlapped area. The axle of the first rotor and the axle of the second rotor are concentric and non-coaxial. The second rotor has permanent magnet array, ferromagnetic or conductive material to couple with the first rotor at the sphere zone surfaces. The rotation of the first rotor causes magnetic force to drive the second rotor. The transmission ratio will depend on the average zone radius ratio of two coupling rotors and the pair number ratio of magnets in magnetic arrays.

### BACKGROUND OF THE INVENTION

1. Field of the invention

The present invention relates generally to magnetic coupling, and more particularly to sphere zone coupling of magnetic rotors for drive devices, and multiple applications can apply in magnetic drive mechanism and combination to work for efficient torque transmission.

2. Description of the Related Art

Mechanical gear will generate much noise, vibration and wear than magnetic gear. Mechanical gears need lubrication and more maintenance for wear and tear. While magnetic gear can provide better benefits from mentioned problem in transmission system. Recent advances in the material research have developed powerful magnets and applied in wide range of use for magnetic transmission. Thus make the magnetic gear to be workable in industrial application.

Generally magnetic coupling of gear is the magnet arrays arranged at a circumferential radius to work with cylindrical or disk-shaped drive rotating members. In such a magnetic device the magnetic coupling is radial coupling at different rotating radius. The interaction force is strong at the closest position, and weak as the air-gap increased from the central closest position. Axial and disk-shaped magnetic coupling of gears can work better because consistent air-gap between magnetic arrays. While the interaction faces have limits and make the magnetic area to be large for efficiency. And the rotating axles of radial or axial coupling of magnetic devices need to be parallel with structure design. Some magnetic spur gears can work in angled axial position but are the same as cylindrical type to have strong interaction at the closest position only. Thus make the magnetic devices work less efficient. However, there are still needs for increased torque interaction and some better utilization of the permanent magnets to work in magnetic couplings and transmission devices.

Because a lot of the magnetic couplings are less efficient and cannot assist in transferring torque, and magnetic coupling cannot work as mechanical gears in transmission methods. The magnetic application of transmission is not so wide for industrial application as mechanical systems. The reasons might due to directional restriction of coaxial or parallel type of magnetic transmission system. So comparing with some mechanical mechanism, non-coaxial or angled magnetic transmission system has some more usages and freedom in transmission design. There are needs for better improvement in magnetic coupling systems.

The present invention provides a solution to the above problems by sphere zone coupling to increase effective coupling interaction and minimize whole air gap of working area. This means like two different sphere zones of a sphere to couple with some overlapped area for magnetic drive. Basically sphere zone couplings have more freedom in axial arrangements and choices of transmission ratio. A large torque can be transmitted from sphere zone coupling system. These non-parallel and angled axial arrangements of magnetic coupling devices have practice value and un-replaceable benefits in rotary transmission designs. Furthermore multiple applications from sphere zone couplings can work as coaxial and parallel coupling systems and have better performance.

More particularly, combination of sphere zone couplings can work from one input drive to multiple outputs. Alternatively sphere zone couplings can work from multiple inputs to collect driving forces to single output. Thus the sphere zone coupling systems can use for adaptive magnetic devices in wide range.

### SUMMARY OF THE INVENTION

The present invention relates to sphere zone coupling of magnetic rotors of devices, and multiple applications for magnetic transmission. The sphere zone coupling of the present invention can possess a variety of embodiments based on different coupling arrangements or combinations for drive and transmission.

An embodiment of sphere zone coupling of magnetic devices preferably includes at least one magnetic rotor having permanent magnet array at the radial sphere zone face, and a second rotor having permanent magnet array, ferromagnetic or conductive material at the radial sphere zone face. The sphere zone faces of two rotors have almost the same sphere radius. The zone radius of two rotors can be the same or different at constant ratio as gear ratio for drive coupling, and the transmitting ratio depends on zone radius ratio and number ratio of the magnet pairs of magnetic arrays of coupling. Two rotors are non-coaxial and concentric coupling at the sphere zone faces with the maximum overlapped area. When the first rotor rotates will drive the second rotor with magnetic interactive force to rotate. Basically two rotors were coupling with about the same sphere radius, the air-gap between two rotors in overlapped area will be consistent and can retain as close as possible for maximum magnetic coupling for transmission.

In certain embodiments, the present invention provides mechanism design of drive with multiple gear rotors to transmit torque to single output rotor and axle. The rotors of sphere zone coupling can generate efficient transmitting forces. And the gear ratios have more freedom than traditional magnetic coupling in mechanism design.

Particular embodiment of the present invention provides mechanism design of single drive with two opposite gear rotors fixing in one axle with same rotating direction. Thus the driving and transmitting force will be double and combined to output.

In other embodiments, the present invention provides mechanism design of drive with several transmitting gears to transport driving forces to output rotor and axle. Thus greater torque can be transmitted from the combination of multiple sphere zone couplings to the specified output rotor. Additionally different gear rotors can output torque as different transmitting systems in different directions from the drive. So in the coordinating system some gear rotors can be transporting gears and some rotors can be output gears. The mechanism design has more freedom for multiple outputs or torque transmissions.

In further embodiments of the present invention, instead of rotating the drive rotor when the carrier frame of gear rotors rotates with constant speed, the output rotor can rotate with ratio speed plus carrier driving speed. The features and functions will be the same as the planetary gears for the best transmission and performance from efficient sphere zone couplings.

The present invention provides several technical advantages. For example, because magnetic flux is penetrated magnetic body and can work in opposite faces of magnet. Generally magnetic design works with one face of magnets or one side of magnetic arrays. Some structures design double sides coupling but have high limit in axial arrangement. For sphere zone couplings of magnetic arrays beside the basic working face the opposite side can adapt other magnetic devices. Two sphere zone faces of main rotor can be designed to work at different sphere center for space arrangements. The sphere zone couplings have more freedom in axial and mechanism design. Thus the advantages are quite apparent.

Instead of using magnetic rotors, the drive can be electromagnetic drives like electric stator with sphere zone coupling in mechanism design. Stator works like the drive of magnetic arrays. Thus can achieve same advantages of the present invention and work in more wide industrial applications.

Additional features and advantages of the invention will be set forth in the description as embodied in sphere zone coupling of magnetic transmission, it is nevertheless not intended to be limited to the details shown, since various modifications and structural changes may be made therein without departing from the spirit of the invention and within the scope and range of equivalents of the claims. The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1. is a explanatory view of the sphere zone coupling of magnetic rotors of the present invention.

FIG. 2. is a explanatory view showing prior art of the magnetic couplings of cylindrical types.

FIG. 3. is a explanatory view showing prior art of the magnetic couplings of disk-like types.

FIG. 4. is a explanatory illustration showing principle of sphere zone couplings.

FIG. 5. is a explanatory view showing the sphere zone coupling of one drive with two gear rotors fixed in one axle for efficient transmission.

FIG. 6. is a explanatory view showing the sphere zone coupling mechanism like planetary gear.

FIG. 7. is a explanatory view showing a transmitting and coordinating system of sphere zone couplings.

FIG. 8. is a explanatory view showing a different transmitting and coordinating system than FIG. 7.

FIG. 9. is a explanatory view showing a design to drive the carrier frame of gear rotors of the present invention.

FIG. 10. is a explanatory view showing two systems of the present invention working with one magnetic array of rotor at both sides.

FIG. 11. is a explanatory view showing a unsymmetrical mechanism of the present invention.

FIG. 12. is a explanatory view showing a comparison of mechanism arrangements from the present invention.

### DETAILED DESCRIPTION OF PREFERRED EMBODIMENTS

Detailed descriptions of preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

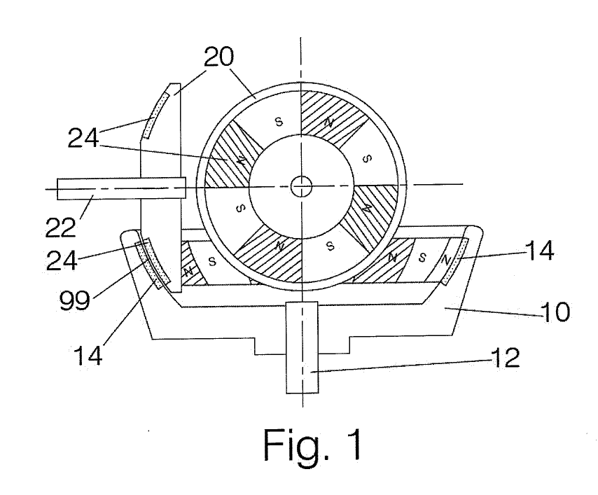

In FIG. 1, a first rotor 10 with magnetic array 14 in annular and arranged to comprise a sphere zone face. The magnetic array is provided with a plurality of magnetic poles of comprising opposite polarity next to each other in turn. The first rotor 10 is supported for rotation about a first axle 12.

A second rotor 20 is provided with magnetic array 24 in annular and arranged to comprise a sphere zone face which has almost the same sphere radius as the sphere zone face of the first rotor, but the zone radius can be the same or different for the different gear ratio arrangements. Transmission ratio is the ratio of two zone radius ratio with magnetic array arrangements and the number ratio of the magnet pairs of magnetic arrays of coupling. The second rotor 20 is supported for rotation about a second axle 22. Two rotors are coupling at the sphere zone faces with the maximum overlapped area for magnetic coupling forces. In FIG. 1, two sphere zones are perpendicular coupling , while not limited to perpendicular and just explanatory for better understanding the principle of sphere zone coupling. Alternatively for the first or second rotor, one of two magnetic arrays can be replaced by ferromagnetic or conductive material to produce magnetic working force, and achieve some or similar effect as magnetic array in transmitting torque. The first axle 12 and the second axle 22 are concentric and non-coaxial arrangement. Two rotors are contactless and have consistent and small air-gap 99 between the overlapped sphere zone faces. And if possible some more gear rotors can be arranged to couple with drive rotor to induce more torque to other outputs, or collect more torque to single output. If collecting for single output the gear rotors need to be the same zone radius to couple with drive rotor and output rotor. If designed for different outputs, the gear rotors can be different in zone radius for different transmissions and axle alignments in the system. Herein if use electromagnetic stator with sphere zone coupling method as the drive the work will be similar.

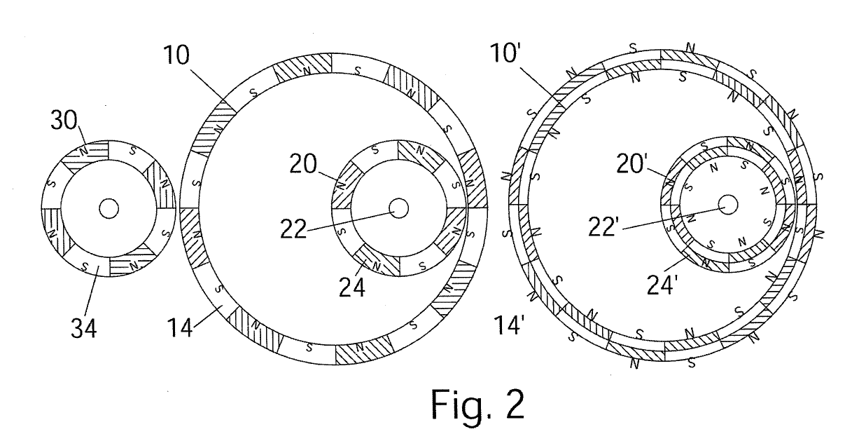

In FIG. 2 of prior art of cylindrical magnetic coupling of gears, two rotors have the strongest working force at the closet position and become weaker as the air-gap increase from the closest position because of the different or opposite radius in coupling. The axles of cylindrical coupling should be paralleled, and are difficult to design if inside coupling for better magnetic working method.

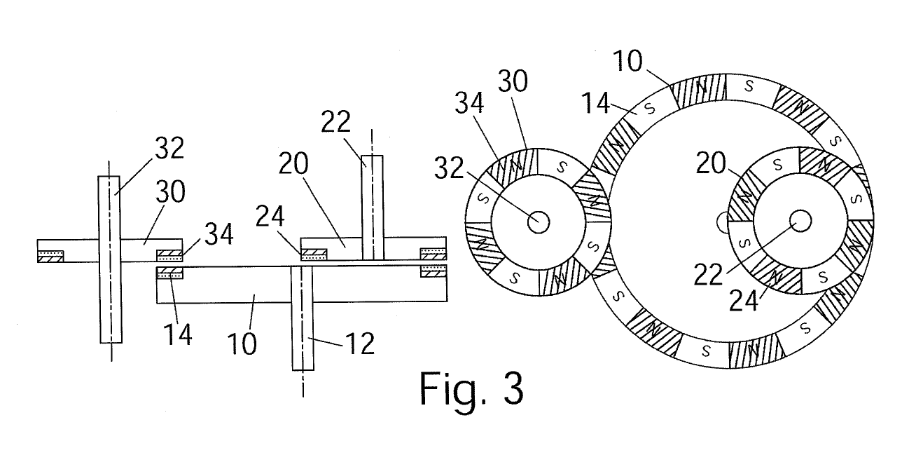

In FIG. 3 of prior art of disk-shaped magnetic coupling of gears, two rotors have consistent and small air-gap. The axles of disk-shaped coupling also need to be paralleled. If inside coupling the axle design is more difficult than cylindrical coupling because structure confliction between disks and axles. There are some magnetic spur gears, the axial arrangements can be better but the working methods are similar to cylindrical couplings. The magnetic working forces become weak from increased air-gap outside the central close area.

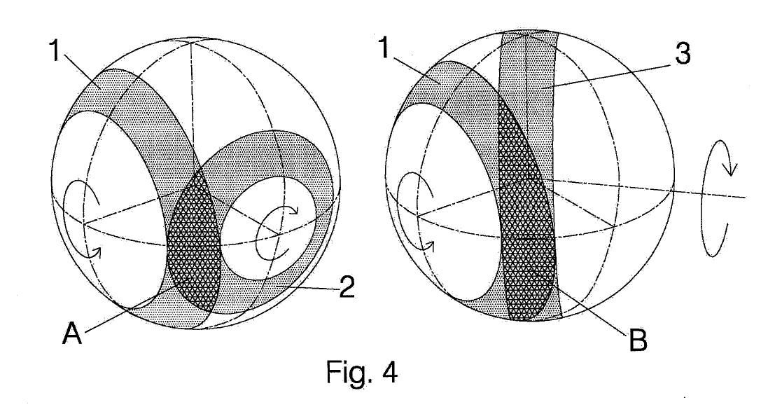

While for the sphere zone coupling, the axle design has more freedom than prior art. From FIG. 4 of explanatory illustration of sphere zone couplings, sphere zone 1 couples with sphere zone 2 at the overlapped area A. Sphere zone 1 can couple with different sphere zone 3 with overlapped area B. In a sphere face, different zone radius and zone axle arrangement for coupling will have different overlapped area. The air-gap is consistent in overlapped area because the same sphere radius. In a sphere system two rotors have much freedom in zone choices for gear ratio choices. The transmission ratio is the zone radius ratio and the number ratio of magnet pairs in annular magnetic array. For coupling design, the maximum overlapped and working area will be two equatorial zones like zone 3 to coupling as gear ratio of 1, the overlapped area is full sphere zone. This is similar as cylindrical coupling. And compared with the disk-shaped couplings, it will be similar as two pole zones like zone 2 to couple. Such the sphere zone couplings also have the advantages of prior art and better benefits.

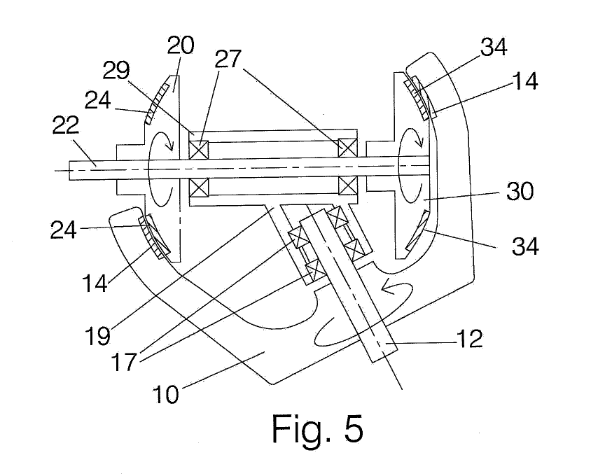

Particularly as show in FIG. 5, drive rotor 10 with magnetic array 14 and axle 12 couples with two same or similar gear rotors 20 with magnetic arrays 24 and axle 22. Two gear rotors 22 are fixed in one axle 22. The coupling is designed for magnetic array 12 of drive rotor 10 to work in different sides of magnetic array 24 of gear rotors 20 in referring position on driving side. Rotors are concentrically constructed at the supporting frame 19 with drive bearings 17 and gear bearings 27. In this way two gear rotors will rotate in same rotating direction for efficient transmission. Thus the coupling and driving force will be double than single coupling in a simple transmitting mechanism.

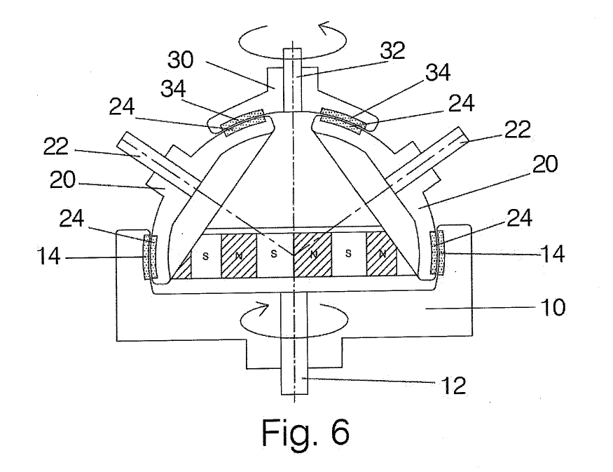

As show in FIG. 6, drive rotor with magnetic array 14 and axle 12 couples with two gear rotors 20 with magnetic arrays 24 and axles 22 and transmits torque to output rotor 30 with magnetic array 34 and axle 32. In such as planetary gear mechanism of sphere zone coupling there is some space inside of coupling rotors for construct the joint or connecting structure. For example of FIG. 5 the axles of drive rotor 10 and output rotor 30 need to be coaxial. So output rotor 30 can be design with bearing loaded at the same axle 12 of drive rotor 10. Or in FIG. 6 to add some more joints, two axles 12 and 32 connect with coaxial and bearing loaded structure inside rotors. Then the system will be more stable and rigid in working. Some more rotors also can add for more torque transmission or output torque to other sources.

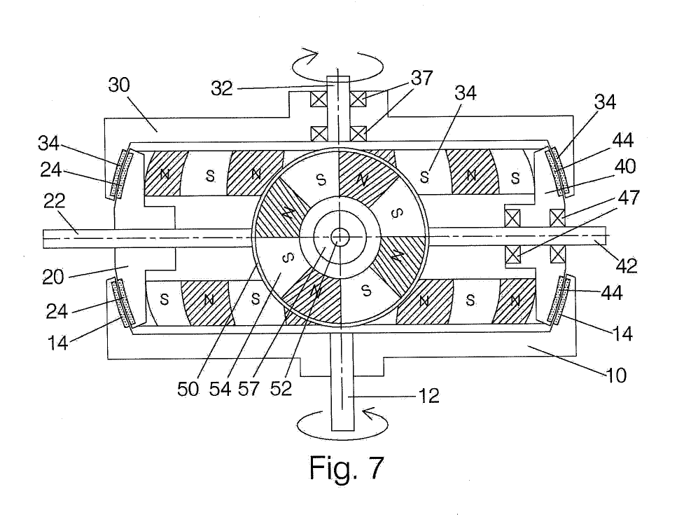

In FIG. 7 of transmitting and coordinating system, drive rotor 10 will rotate rotors 20, 40, 50 and through the transmission to drive the rotor 30. Rotors have magnetic arrays 14, 24, 34, 44, 54 and axles 12, 22, 32, 42, 52. In this or similar arrangement rotor 30 can be as a transporting gear to transmit torque from rotor 40 or 50 to rotor 20. The rotor 20 will collect more torque in this way for more output torque. So some rotors can be output rotor and some rotors can be transporting rotors. More rotors can be added for transporting torque or output torque to other sources. This will be depended on the zone space between rotor 10 and 30 for gear arrangement. Rotor 30 can be another drive input with same rotating speed as rotor 10 and opposite rotating direction.

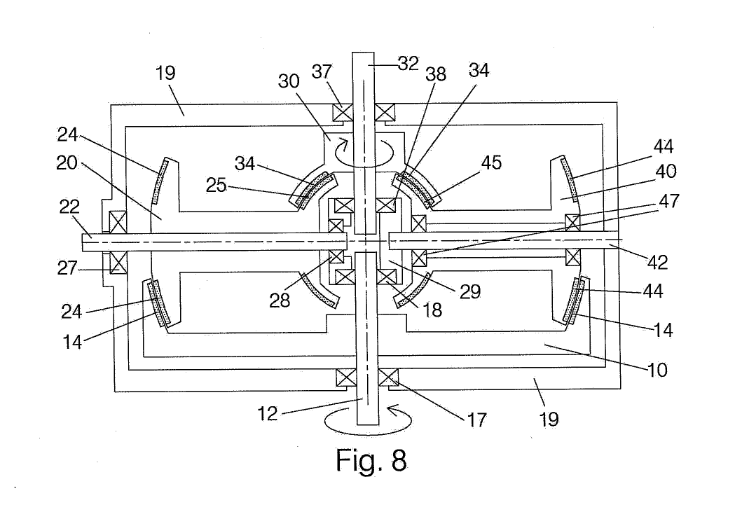

FIG. 8 shows a different design of transmitting and coordinating system from FIG. 7. With magnetic array 14 and axle 12, rotor 10 will drive gear rotor 20 and 40 with magnetic arrays 24, 44 and axles 22, 42. Rotors 20 and 40 have another sphere zone coupling system than rotor 10 to transmit torque to rotor 30 with axle 32 and magnetic array 34. Rotors 20 and 40 have another magnetic array 25, 45 for the different sphere zone coupling with rotor 30. Rotors and axles are constructed at the supporting frame 19 with bearings 17, 18, 27, 28, 37, 38, 47. And there is a central connecting frame 29 for supporting and axle arrangements. Rotor 30 can be output rotor or transporting rotor. Rotor 20 also can be output rotor. More rotors can be added at the annular position of magnetic array 14 of rotor 10 for the similar coupling way. It'll be notice that rotor 30 and axle 32 also can be installed at the vertical position to rotor 10 and rotor 20. Alternatively in this way two of similar like rotor 30 can be vertically installed at opposite coupling position with rotor 20 and 40 for efficient torque transmission.

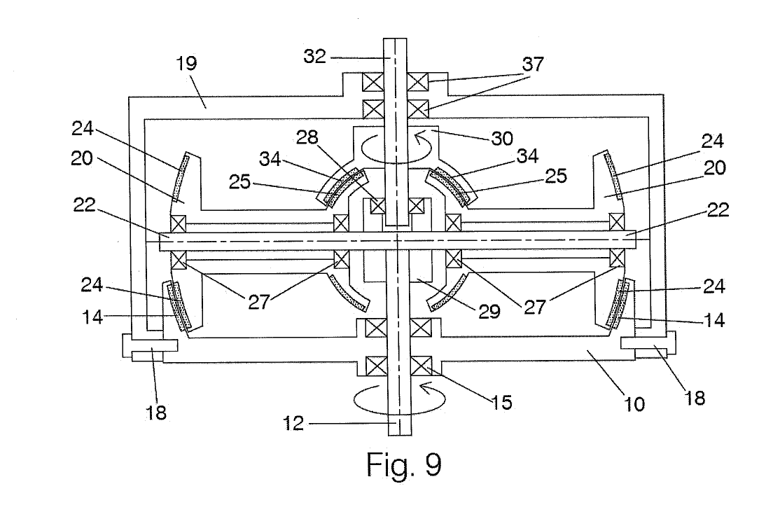

For planetary gear when rotate the planetary gear frame instead to rotate the sun gear, the transmitting speed will be the ratio speed plus the driving speed. In FIG. 9 rotor 10 with axle 12 and magnetic array 14 is fixed at the supporting frame 19 and bearings 17 with bolts 18. Two gear rotors 20 with magnetic arrays 24, 25 and bearings 27 are fixed at axle 22. Axle 22 is fixed at the carrier flange 29 with the drive axle 12. The drive axle 12 rotates the carrier flange 29 and axle 22. Thus the torque is transmitted from outside sphere zone coupling system to rotor 30 with magnetic array 34 and axle 32 through the inside sphere zone coupling system for output. In this way rotor 30 can achieve higher speed and better performance. And axle 32 of rotor 30 can connected to carrier flange 29 and axle 12 with bearing 28 for construction stability. More gear rotors like rotor 20 can be added for better efficiency.

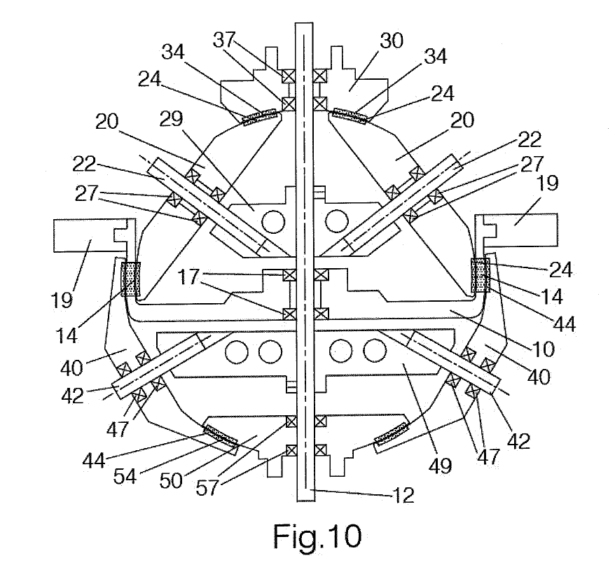

Magnetic flux will penetrate the magnetic body. Magnetic field exists at the both side of magnetic array. Such the usage of magnetic coupling can work in double sides of magnetic array. In FIG. 10 rotor 10 with magnetic array 14 is fixed at the supporting frame 19.

Magnetic array 14 is arranged to form two sphere zone faces at the inner side as well as the outer side, and magnetic contacting faces are clear for coupling. Drive axle 12 is fixed with carrier flange 29 and supporting on rotor 10 with bearings 17. Two rotors 20 with magnetic arrays 24 are sphere zone coupling with rotor 10 at the inner side of magnetic array 14 and pivoted on the axles 22 with bearings 27 at the carrier flange 29. Rotor 30 with magnetic array 34 is coupling with two gear rotors 20 and pivoted at axle 12 with bearings 37. When input drive from axle 12 will rotate the carrier flange 29 and transmit torque through gear rotors 20 to rotor 30 to output. Besides the inner coupling of magnetic array 14, there is another sphere zone coupling system to work at the outside field of magnetic array 14. Axle 12 is fixed with another carrier flange 49. Two gear rotors 40 with magnetic arrays 44 are sphere zone coupling with rotor 10 and pivoted on the axles 42 with bearings 47 at the carrier flange 49. Another rotor 50 with magnetic array 54 is coupling with two gear rotors 40 and pivoted at axle 12 with bearings 57. When input drive from axle 12 will rotate the carrier flange 49 and transmit torque through gear rotors 40 to rotor 50 to output. So there are two sphere zone coupling systems to work at the different sides of magnetic array 14. It'll be notice that inner and outer sphere zones of magnetic array can be non-concentric, meaning besides different zone radius the different systems can be having different sphere center in arrangement. Thus two sphere zone coupling systems can work in one main rotor. There in much freedom in transmitting ratio design as the figuration. More gear rotors can be added and will depend on the space as well as structure compatibility. Alternatively in FIG. 10 if fix the carrier flanges 29, 49 and rotate rotor 10 by changing joints and supporting structure, there will be 2 sphere zone coupling systems like FIG. 6 to work with rotor 10. So as if use electromagnetic stator to work as drive of magnetic array 14 of rotor 10 to couple with the systems, then can have the same functions and advantages in industrial applications.

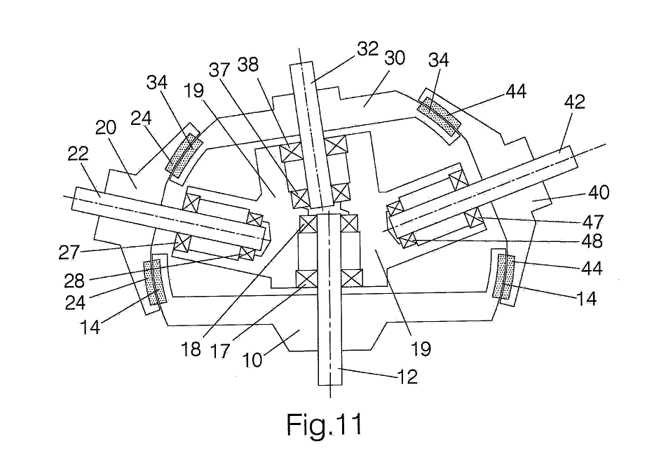

Besides symmetrical structures, FIG. 11 shows an unsymmetrical system of sphere zone couplings. Rotors 10, 20, 30, 40 with magnetic arrays 14, 24, 34, 44 and axles 12, 22, 32, 42 are pivoted at supporting frame 19 with bearings 17, 18, 27, 28, 37, 38, 47, 48. FIG. 11 takes an example of zone radius ratio about 8:3:6:4 for rotors 10, 20, 30, 40. If drive rotor 10 with rotating speed of 60 rpm, speed of rotor 20 will be about 160 rpm, rotor 30 about 80 rpm, rotor 40 about 120 rpm. Four rotors coordinate and transmit torque in a close cycle and connecting system. Each rotor can be input source or output source. In FIG. 11 rotors of zone radius ratio between 3 and 4 in this formula can be installed between rotor 10 and rotor 30. Rotors of zone radius ratio between 6 and 8 in this formula can be installed between rotor 20 and rotor 40. There is quite wide range for transmission design at similar configurations.

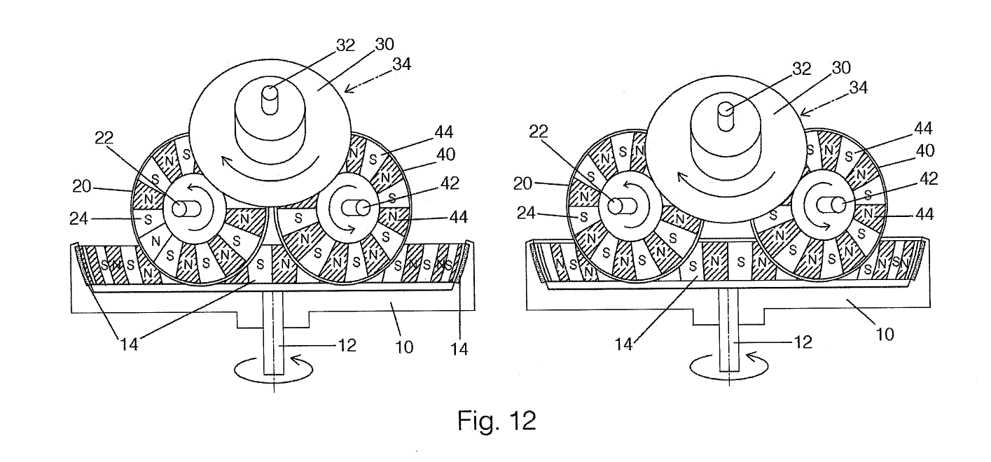

FIG. 12 shows the flexibility in mechanism design from sphere zone couplings. Rotors 10, 20, 30, 40 are coupling together with magnetic arrays 14, 24, 34, 44 and axles 12, 22, 32, 42. Rotor 10 couples with two rotors 20, 40 and works as drive input. Two rotors 20 and 40 can be the same. Rotor 30 couples with rotors 20, 40 and works as a transporting gear. If drive rotor 10, rotor 20 will rotate. For rotor 20 beside the interaction with rotor 10, there is more torque can be transferred from rotor 40 through rotor 30 to rotor 20. In FIG. 12 at the same configuration another similar transferring rotors also can be installed at left side of rotor 20 to collect more torque to rotor 20 for better performance. At this mechanism and function gear rotors 20 and 40 need to be close for cost saving and structure connection. FIG. 12 shows two arrangements of rotors in different positions. At left side of arrangement, rotor 20 and 40 are close and rotor 30 is higher and far to rotor 10. At right side of arrangement, rotor 20 and 40 are a little far and rotor 30 is lower and close to rotor 10. The adjustments need to work with magnetic array arrangements and coupling alignments. Such there are design flexibility and mechanism freedom for sphere zone couplings of magnetic devices.

As descript above, the sphere zone coupling of the present invention is suitable for magnetic devices. And there are multiple applications of the present invention for magnetic system design in wide range. While the present invention has been described in connection with what is considered the most practical and preferred embodiment, it is understood that this invention is not limited to the disclosed embodiments but is intended to cover various arrangements included within the spirit and scope of the broadest interpretations and equivalent arrangements. The present invention is in no way to limit in described configurations. Moreover, variations and changes may be made by those skilled in the art without departing from the spirit of the invention. Accordingly the scope of the invention should be limited only by the claims and the equivalences thereof.

What is claimed is:

1. The sphere zone coupling of magnetic rotors for transmission comprising:
a first rotor having an annular magnetic array arranged to form said sphere zone face, the first rotor having a rotational axle;
a second rotor having an annular magnetic array arranged to form said sphere zone face, the sphere radius is about the same as the sphere radius of the first rotor, the second rotor having a rotational axle;
a sphere zone coupling means two rotors are magnetically coupling at the overlapped area of their said sphere zone faces with small air-gap, two rotors are non-coaxial and concentric in coupling arrangement, whereby rotation of the first rotor causes rotation of the second rotor by way of magnetic interaction between rotors.

2. The sphere zone coupling as defined in claim 1, wherein the position of magnetic array of the second rotor in said sphere zone face is installed with ferromagnetic or conductive material to couple with the magnetic array of the first rotor, whereby the rotation of magnetic array of the first rotor causes rotation of the second rotor by way of magnetic interaction between rotors.

3. The sphere zone coupling as defined in claim 1, wherein at least one of the motor rotors comprises dual magnetic arrays in radial position to form dual sphere zone faces.

4. The sphere zone coupling of magnetic devices as defined in claim 1 further comprising:
a plurality of magnetic rotors having an annular magnetic array arranged to form said sphere zone face, each rotor having rotational axle or shared axle;
a plurality of magnetic rotors arranged to couple in said sphere zone faces of annular magnetic arrays; and
at lease two of rotors being non-coaxial and concentric;
wherein rotors are coupling to transmit torque from input drive to output rotor or axle;
mounting means rotors and axles being installed concentrically with supporting frame and bearings.

5. The sphere zone coupling of magnetic devices as defined in claim 1 further comprising:
a plurality of magnetic rotors arranged to form a close cycle and connecting system of sphere zone couplings for transmission, a close cycle is forming by at least four and even number of rotors; and
a plurality of gear rotors having the same zone radius to transfer torque between drive rotor and output rotor;
wherein rotors are coupling to transmit torque from each other to thereby coordinate and transmit combined torque to specified rotor or axle.

6. The sphere zone coupling of magnetic devices as defined in claim 1, wherein adaptive rotors or systems of sphere zone coupling of magnetic rotors can be installed for different output or input.

7. The sphere zone coupling of magnetic rotors for transmission comprising:
a first rotor having an annular magnetic array arranged to form said sphere zone face, magnetic array facing to inside of said sphere, the first rotor having a rotational axle;
a second rotor having an annular magnetic array arranged to form said sphere zone face, magnetic array facing to outside of said sphere, the second rotor having a rotational axle; and
a third rotor having an annular magnetic array arranged to form said sphere zone face, magnetic array facing to outside of said sphere, said the sphere and sphere zone radius are the same as the second rotor, the third rotor is fixed on axle of the second rotor;
the sphere zone coupling means rotors are magnetically coupling at the overlapped area of their said sphere zone faces with small air-gap, the second and the third rotor are installed inside of the magnetic array of the first rotor, rotors are arranged concentrically to couple;
and the magnetic array of the first rotor couples the different sides of magnetic arrays of two other rotors of rotating axle in referring of the first rotor's side, two other rotors are in the opposite position of the said sphere center and the annular magnetic array of the first rotor, whereby rotation of the first rotor causes rotation of the second and the third rotors in the same rotating direction on axle to output combined torque;
mounting means rotors and axles being installed concentrically with supporting frame and bearings.

8. The sphere zone coupling as defined in claim 7 in which the position of magnetic array of rotor in said sphere zone face is installed with ferromagnetic or conductive material to couple with the magnetic array of the other rotor, whereby the rotation of magnetic array of the rotor causes rotation of the other rotor by way of magnetic interaction between rotors.

9. The sphere zone coupling of magnetic devices for transmission comprising:
a first rotor having an annular magnetic array arranged to form said sphere zone face, the first rotor having a rotational axle and working for input drive;
a second rotor having an annular magnetic array arranged to form said sphere zone face, the said sphere radius is same as the said sphere radius of the first rotor, the second rotor being coaxial with the first rotor;
a plurality of magnetic gear rotors having an annular magnetic array arranged to form said sphere zone face, the said sphere radius is about same as the said sphere radius of the first rotor, gear rotors having rotational axle, gear rotors coupling between the first rotor and the second rotor; and
at lease two of rotors being non-coaxial and concentric;
wherein rotors are coupling to transmit torque from the first rotor to the second rotor.

10. The sphere zone coupling of magnetic devices as defined in claim 9:
wherein instead of rotating said drive rotor of sphere zone coupling, said drive rotor being fixed;
wherein said gear rotors of sphere zone coupling with said drive rotor being fixed on rotating axle of a said carrier flange fixing at said drive axle;
wherein rotation of said drive axle and said carrier flange causing rotation of said output rotor of sphere zone coupling;
mounting means rotors and axles being installed concentrically with supporting frame and bearings.

11. The sphere zone coupling of magnetic devices as defined in claim 9, wherein
at least one gear rotor having inner and outer magnetic arrays arranged to form two said sphere zone faces to transfer torque from one sphere zone coupling system to the other sphere zone coupling system, said inner or outer meaning to view at the said sphere center, the said sphere radius of two sphere zone faces of rotor being different.

12. The sphere zone coupling of magnetic devices as defined in claim 9 further comprising:
at least one main rotor having an annular magnetic array to form two said sphere zone faces in both sides of magnetic array;
at least two sphere zone coupling systems are working at the both sides of magnetic array of main rotor.

13. The sphere zone coupling as defined in claim 9 in which the position of magnetic array of rotor in said sphere zone face is installed with ferromagnetic or conductive material to couple with the magnetic array of the other rotor, whereby the rotation of magnetic array of the rotor causes rotation of the other rotor by way of magnetic interaction between rotors.

14. The sphere zone coupling as defined in claim 9 in which at least one rotor having dual magnetic arrays in radial position to form dual sphere zone faces.

15. The sphere zone coupling of magnetic devices as defined in claim 9:
at least one said rotor being said like electromagnetic stator to work as input drive, said rotor having said sphere zone face for magnetic interaction, said rotor like stator being concentrically fixed at axle or frame.

16. The sphere zone coupling of magnetic devices as defined in claim 9:
a plurality of magnetic rotors arranged to form a close cycle and connecting system of sphere zone couplings for transmission, a close cycle is forming by at least four and even number of rotors.

17. The sphere zone coupling of magnetic devices as defined in claim 9:
a plurality of sphere zone coupling systems of magnetic rotors to work, said a sphere zone coupling system meaning the rotors are concentrically work at a sphere radius at a sphere center, said different sphere zone coupling system meaning rotors are work at different said sphere radius or said sphere center of couplings.

18. The sphere zone coupling of magnetic devices as defined in claim 9:
wherein adaptive rotors or systems of sphere zone coupling of magnetic rotors can be installed for different output or input.
